(19) United States
(12) Patent Application Publication
(10) Pub. No.: US 2005/0152510 A1
(43) Pub. Date: Jul. 14, 2005

(54) Auxiliary ringer and code screener

(76) Inventor: Joseph W. Ladd, Utica, NY (US)

Correspondence Address: Richard C. Litman;LITMAN LAW OFFICES, LTD., P.O. Box 15035, Arlington, VA, 22215, US

(21) Appl. No.: 10/753,564

(22) Filed: Jan. 9, 2004

(51) Int. Cl. H04M 1/64; H04M 3/00

(52) U.S. Cl. 379/67.1; 379/373.01; 379/419

(57) ABSTRACT

An auxiliary ringer and call screener (ARCS) includes switches, a speaker, a reset button, an input jack, an output jack, and a power connecting jack interconnected with a housing, and ARCS circuitry mounted within the housing. The ARCS may also include an LED which illuminates when the ARCS emits an audible ring. An audible ring is produced through the speaker and a ring back tone is sent from the ARCS to a calling party to indicate that a proper sequence of DTMF codes from the call has been recognized and processed, when sequential incoming DTMF codes from a call from the calling party on the input jack match DTMF codes associated with settings of the switches. An audible ring is prevented from being emitted through the speaker, and a ring back tone is not sent back to the calling party when sequential incoming DTMF codes from the call on the input jack do not match the DTMF codes associated with settings of the switches.

### BACKGROUND OF THE INVENTION

1. Field of the Invention

The present invention relates generally to telephone systems and, more particularly, to an auxiliary ringer and call screener (ARCS).

2. Description of the Related Art

The annoyance that telemarketers and unwanted callers have had on telephone subscribers is well known and has been ongoing for decades. These calls interrupt subscribers' family meals, work, quiet time, etc. A variety of devices and/or technologies have been developed to assist telephone subscribers in determining who the calling party is prior to answering a phone call. For example, Caller ID allows a telephone user to identify the calling party in some instances. However, the receiving party needs to walk to the phone to see the Caller ID information. In addition, calling parties are able to block the Caller ID information. When this occurs, the screen on the user's telephone indicates that no Caller ID information is available. Since friends of telephone subscribers may have blocked their Caller ID information, receiving parties have to decide whether to answer a call with no Caller ID information or risk missing a call from a friend. Telephone subscribers also need a telephone configured with special circuitry to receive Caller ID information, and they normally pay a monthly fee for having Caller ID services from their telephone service provider.

Answering machines have also helped telephone subscribers in avoiding telemarketers or unwanted callers. In some cases users may listen to a message being recorded and answer the call if so desired. However, calls from friends may be missed because messages may not have been left. Usually, telephone subscribers use only one answering machine that answers calls for any number of telephones that are in operation at the subscribers' residence.

There is a need for an ARCS that minimizes the annoyance that telemarketers and unwanted callers have on telephone subscribers, and that facilitates the ability of telephone subscribers to selectively apply and configure for any number of telephones connected to a single telephone line.

The related art is represented by the following references of interest.

U.S. Pat. No. 4,429,188, issued on Jan. 31, 1984 to Thomas E. Allen, describes a telephone call screener in which the dial of the telephone from which the call is placed is used to provide a code signal to the receiving telephone to indicate to the receiving party that a desired call is present on the line. The Allen patent does not suggest an ARCS according to the claimed invention.

U.S. Pat. No. 4,598,179, issued on Jul. 1, 1986 to Lloyd E. Clark et al., describes a telephone privacy system which automatically informs a user when an incoming call is being processed as well as whether or not the caller is an authorize caller, all without requiring the user to divert attention from tasks being performed. The Clark et al. patent does not suggest an ARCS according to the claimed invention.

U.S. Pat. No. 4,827,501, issued on May 2, 1989 to Gregory J. Hansen, describes an apparatus for use at a station for a telephone set to screen telephone calls incoming thereto over telephone lines from a central office. The Hansen patent does not suggest an ARCS according to the claimed invention.

U.S. Pat. No. 4,926,470, issued on May 15, 1990 to David M. Sanford, describes a telephone call screening circuit. The Sanford patent does not suggest an ARCS according to the claimed invention.

U.S. Pat. No. 5,127,045, issued on Jun. 30, 1992 to David R. Cragnun, describes an identifying telephone controller system. An incoming call received by a central processing unit is responded to by a speech synthesizer and a subsequent code entered by a caller, and results in a signal code being annunciated by a speaker. The Cragnun patent does not suggest an ARCS according to the claimed invention.

U.S. Pat. No. 5,127,049, issued on Jun. 30, 1992 to Martin Sabo, describes a telephone security device. The Sabo patent does not suggest an ARCS according to the claimed invention.

U.S. Pat. No. 5,323,456, issued on Jun. 21, 1994 to Dan R. F. Oprea, describes a digitally controlled ringer signal generator. The Oprea patent does not suggest an ARCS according to the claimed invention.

U.S. Pat. No. 5,467,388, issued on Nov. 14, 1995 to James C. Redd, Jr. et al., describes a method and apparatus for selectively blocking incoming telephone calls. The Redd, Jr. et al. patent does not suggest an ARCS according to the claimed invention.

U.S. Pat. No. 5,563,935, issued on Oct. 8, 1996 to J. Gordon Small, describes a telephone answering system with a call. screening circuit. The Small patent does not suggest an ARCS according to the claimed invention.

U.S. Pat. No. 5,651,053, issued on Jul. 22, 1997 to Peter P. Mitchell, describes a call screening service. The Mitchell patent does not suggest an ARCS according to the claimed invention.

U.S. Pat. No. 5,655,016, issued on Aug. 5, 1997 to Keith E. G. Emery, describes an annunciator connectable between a phone line terminal and a telephone. The Emery patent does not suggest an ARCS according to the claimed invention.

U.S. Pat. No. 5,796,809, issued on Aug. 18, 1998 to Nam-Dae Baek, describes a technique for controlling a ring volume and selectively receiving messages by facsimile. The Baek patent does not suggest an ARCS according to the claimed invention.

U.S. Pat. No. 5,802,157, issued on Sep. 1, 1998 to Gail L. Clarke et al., describes a method and apparatus for controlling outgoing calls on a telephone line. The Clarke et al. patent does not suggest an ARCS according to the claimed invention.

U.S. Pat. No. 5,850,435, issued on Dec. 15, 1998 to Douglas A. Devillier, describes an audible caller name identification system and method. The Devillier patent does not suggest an ARCS according to the claimed invention.

U.S. Pat. No. 5,960,064, issued on Sep. 28, 1999 to Mark J. Foladare et al., describes a call screening apparatus for use in completing telephones. The Foladare et al., patent does not suggest an ARCS according to the claimed invention.

U.S. Pat. No. 5,991,367, issued on Nov. 23, 1999 to Greg Robuck, describes a telephone call screener which eliminates unwanted telephone calls and allows desirable calls. The Robuck patent does not suggest an ARCS according to the claimed invention.

U.S. Pat. No. 6,031,899, issued on Feb. 29, 2000 to Woody Wu, describes a method and apparatus for identifying a type of phone call. The Wu patent does not suggest an ARCS according to the claimed invention.

U.S. Pat. No. 6,044,148, issued on Mar. 28, 2000 to Leonard G. Bleile, describes a telephone apparatus for screening calls on the basis of messages containing message data. The Bleile patent does not suggest an ARCS according to the claimed invention.

U.S. Pat. No. 6,128,382, issued on Oct. 3, 2000 to David Borland et al., describes a telephone system and method that enable a caller to leave a message on a telephone without the telephone first generating a ring sound. The Borland et al. patent does not suggest an ARCS according to the claimed invention.

U.S. Pat. No. 6,353,663 B1, issued on Mar. 5, 2002 to Gilman R. Stevens et al., describes a method and apparatus for screening telephone calls. The Borland et al. patent does not suggest an ARCS according to the claimed invention.

U.S. Pat. No. 6,442,249 B1, issued on Aug. 27, 2002 to John T. Miller, Jr., describes a call screening unit. The Miller, Jr. patent does not suggest an ARCS according to the claimed invention.

U.S. Pat. No. 6,456,706 B1, issued on Sep. 24, 2002 to Carolyn S. Blood et al., describes an automatic telephone silent call screening system. The Blood et al. patent does not suggest an ARCS according to the claimed invention.

U.S. Pat. No. 6,618,473 B1, issued on Sep. 9, 2003 to William F. Davis, describes a telephone caller screening device. The Davis patent does not suggest an ARCS according to the claimed invention.

German Patent Application Publication No. DE 3826100 A1, published on Feb. 8, 1990, describes a controlled telephone barring device. The German application does not suggest an ARCS according to the claimed invention.

Japan Patent Application Publication 1-255348, published on Oct. 12, 1989, describes a mischievous/wrong telephone call preventing machine. The Japan application does not suggest an ARCS according to the claimed invention.

None of the above inventions and patents, taken either singularly or in combination, is seen to describe the instant invention as claimed. Thus an ARCS solving the aforementioned problems is desired.

### SUMMARY OF THE INVENTION

The present invention is an auxiliary ringer and call screener (ARCS). The ARCS includes switches, a speaker, a reset button, an input jack, an output jack, and a power connecting jack interconnected with a housing, and ARCS circuitry mounted within the housing. The ARCS may also include a light emitting diode (LED) which illuminates when the ARCS emits an audible ring through the speaker. An audible ring is produced through the speaker and a ring back tone is sent from the ARCS to a calling party to indicate that a proper sequence of DTMF codes from the call has been recognized and processed, when sequential incoming DTMF codes from a call from the calling party on the input jack match DTMF codes associated with settings of the switches. An audible ring is prevented from being emitted through the speaker, and a ring back tone is not sent back to the calling party when sequential incoming DTMF codes from the call on the input jack do not match the DTMF codes associated with settings of the switches.

When the ARCS is interconnected between an answering machine and a telephone line using telephone cords, and a sequence of DTMF tones are designated on the ARCS with the switches, the ARCS is subsequently configured for detecting the designated sequence of DTMF tones. When the answering machine is configured to answer an incoming call on a predetermined ring, a prerecorded message is generated informing the calling party of the incoming call that the calling party should enter the sequence of designated DTMF tones in order to ring a telephone interconnected with the answering machine. When sequential incoming DTMF codes on the input jack match the DTMF codes associated with the settings of the switches on the ARCS, a ring back tone is then sent back from the ARCS to the calling party to indicate that the proper sequence of designated DTMF tones has been entered and a telephone ringer is active.

When sequential incoming DTMF tones on the input jack do not match DTMF tones associated with settings of the switches, the ARCS does not produce an audible ring through the speaker, no ring back tone is sent to the calling party, and the telephone interconnected with the answering device does not ring. A voice emergency call may be passed through to the called party at the time of a call, and the voice emergency call may be saved on the answering machine.

Accordingly, it is a principal aspect of the invention to provide an ARCS method that provides an ARCS with a housing, a plurality of switches interconnected with the housing, a speaker interconnected with the housing, a reset button interconnected with the housing, an input jack interconnected with the housing, an output jack interconnected with the housing, a power connecting jack interconnected with the housing, and ARCS circuitry mounted within the housing. The plurality of switches are set with a corresponding number of DTMF tones. Incoming DTMF tones are decoded from a calling party. An audible ring is produced through the speaker of the ARCS and a ring back tone is sent from the ARCS to a calling party to indicate that the proper sequence of DTMF codes has been recognized and processed, when sequential incoming DTMF codes from a call on the input jack match the DTMF codes associated with the settings of the plurality of switches.

It is another aspect of the present invention to provide an ARCS that includes a housing, a plurality of switches interconnected with the housing, a speaker interconnected with the housing, a reset button interconnected with the housing, an input jack interconnected with the housing, an output jack interconnected with the housing, a power connecting jack interconnected with the housing, and ARCS circuitry interconnected with the housing. An audible ring is produced through the speaker of the ARCS and a ring back tone is sent from the ARCS to a calling party to indicate that the proper sequence of DTMF codes has been recognized and processed, when sequential incoming DTMF codes from a call from the calling party on the input jack match DTMF codes associated with settings of the plurality of switches.

It is an aspect of the invention to provide improved elements and arrangements thereof in an ARCS for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an environmental view of an ARCS interconnected between a telephone and a telephone line according to the present invention.

FIG. 2 is a top perspective view of an ARCS according to the present invention.

FIGS. 3A, 3B, 3C, 3D, 3E, and 3F are schematic diagrams of ARCS circuitry according to the present invention.

Similar reference characters denote corresponding features consistently throughout the attached drawings.

### DETAILED DESCRIPTION OF THE PREFERRED EMBODIMENTS

The present invention is an auxiliary ringer and call screener (ARCS). The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

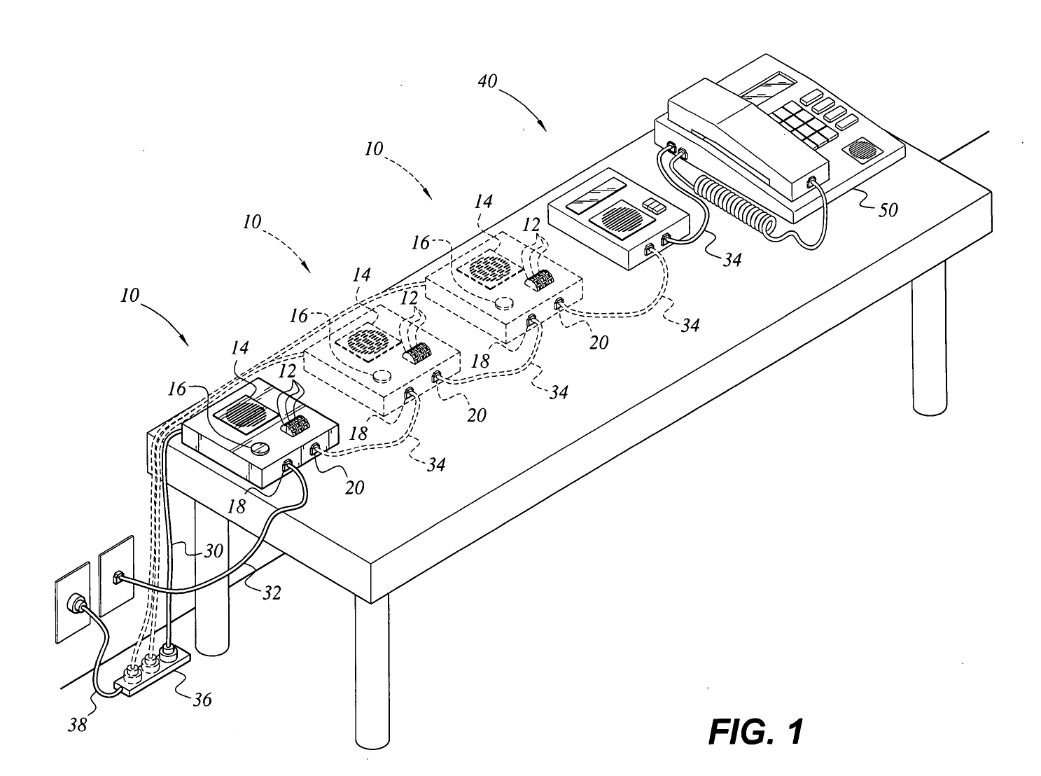

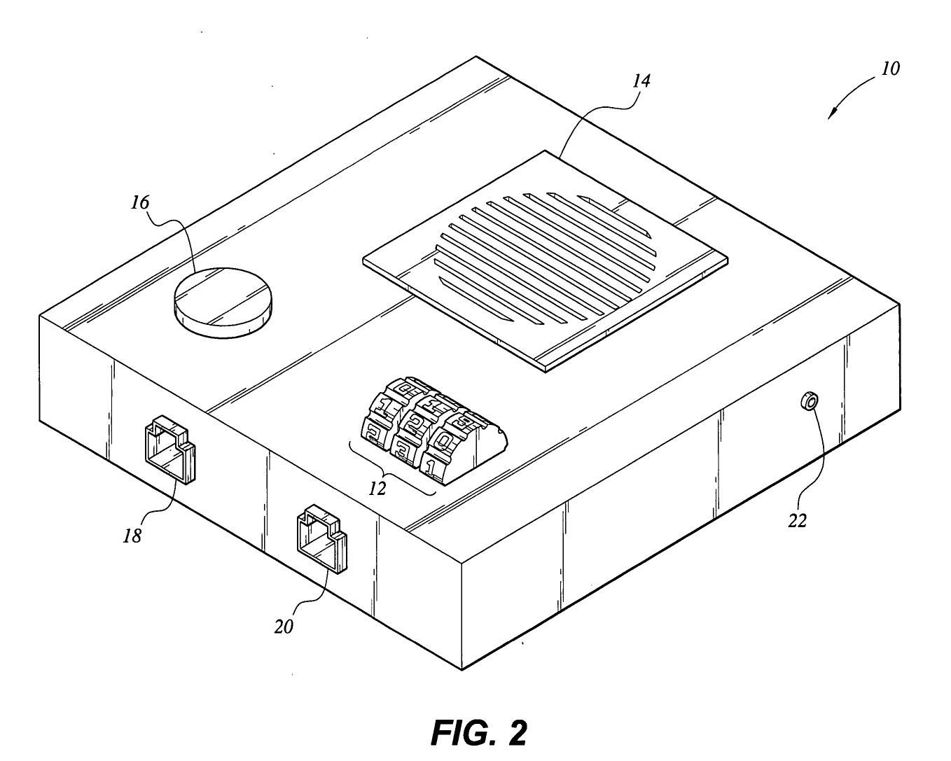

Referring to the drawings, FIG. 1 illustrates the use of one or more ARCS devices 10 with an automatic answering machine 40 and a telephone 50. While three ARCS devices 10 are shown in FIG. 1, it is the inventors full intent to enable the use of any number of ARCS devices 10 with an automatic answering machine 40 and/or a telephone 50. The ARCS devices 10 are serially interconnected between the answering machine 40, the telephone 50, and a telephone service provider's central office (not shown) using telephone cord 32 and telephone cords 34.

Each ARCS 10 includes a housing configured with switches 12, a speaker 14, a reset button 16, an input jack 18, an output jack 20, a power connecting jack 22, and internal ARCS circuitry. Each ARCS 10 may also include an LED which illuminates when the ARCS 10 emits an audible ring through the speaker 14. Such an LED preferably emits a red light, but may emit any color of light. The housing may be dimensioned according to the desires of the user, and may be made from any durable material, such as plastic, metal, rubber, or the like. Each ARCS 10 is interconnected with utility power via power connecting jack 22 and power cord 30 via a power strip 36, and is interconnected with a telephone line of a public telephone network via input jack 18, telephone cord 32, and an AC adapter (not shown). An ARCS 10 may also be interconnected with a telephone 50 via output jack 20 and telephone cord(s) 34.

Each ARCS 10 is configured to operate on regulated DC power received from an external power source. However, each ARCS 10 may also include an internal power source (not shown), such as a rechargeable or non-rechargeable battery or the like, according to the desires of the user. The power connecting jack 22 is included for connecting the ARCS 10 to an external power source, such as utility AC power or the like that has been transformed to DC power through rectifier circuitry or an AC adapter. These elements may be of any type well known in the art. While the ARCS devices 10 are shown serially interconnected between each other, the answering machine 40, the telephone 50, and a telephone line, each ARCS 10 may alternatively be independently interconnected between the telephone answering machine 40 and a telephone line.

The telephone 50 may be any known telephone device, such as a conventional analog telephone, a digital telephone, a cordless telephone, or the like. The telephone 50 includes a hook switch to connect and disconnect the telephone 50 from the public telephone network. The telephone 50 also includes a handset with a speaker and a microphone, and a keypad, as is well known. When a user uses the telephone 50 to make a call, the user picks up the handset, the hook switch senses the completion of the phone loop, and the telephone plays a dial tone sound through the handset speaker so the user knows that the hook switch and the telephone 50 are working. The user then dials a telephone number using the keypad. Known Dual Tone Multi Frequency (DTMF) tones associated with the digits on the keypad are sent through the telephone line in a conventionally known manner. If the number is busy, the user hears a busy signal.

The ARCS 10 is configured so a user may use any number of switches 12, such as three or the like, to designate a corresponding number of DTMF tones that the ARCS 10 is configured for detecting. Switches 12 may be any type of switches, such as toggle switches or the like. When the ARCS 10 has been assigned the DTMF tones, the ARCS 10 decodes incoming DTMF tones from a calling party. When sequential incoming DTMF codes on the input jack 18 match the DTMF codes associated with the settings of the switches 12, the ARCS 10 produces an audible ring through speaker 14, and a ring back tone is sent to the calling party to indicate that the proper sequence of DTMF codes has been recognized and processed. When sequential incoming DTMF codes on the input jack 18 do not match the DTMF codes associated with the settings of the switches 12, the ARCS 10 does not produce an audible ring through speaker 14, and no ring back tone is sent to the calling party.

As shown, one or more ARCS devices 10 may be interconnected between the answering machine 40, telephone 50, and the telephone line. For example, an individual who has two frequent callers may interconnect two ARCS devices 10 between his/her telephone 50 and a telephone line. The user may then designate different sequences of DTMF tones on each of the ARCS devices 10 using associated switches 12. When either one of the frequent callers calls and enters the corresponding sequence of DTMF tones, the associated ARCS 10 emits a particular audible ring, wherein the individual may recognize who the calling party is prior to answering the telephone 50. For example, if a family member or relative calls, the switches 12 of one interconnected ARCS 10 may be set to emit a high pitch tone. At the same time, switches 12 of another interconnected ARCS 10 may be set to emit a low pitch when a configured a friend or business associate calls.

As previously described, the one or more ARCS devices 10 may be interconnected between an answering machine 40 and a telephone line using telephone cords 34, as described above with respect to the interconnection of the ARCS devices 10 between a telephone 50 and a telephone line. Upon designating a sequence of DTMF tones on each ARCS 10 with switches 12, each ARCS 10 is subsequently configured for detecting the sequence of designated DTMF tones. The answering machine 40 may be configured to answer an incoming call on a first or subsequent ring, and generate a prerecorded message informing the caller that the caller should enter the sequence of designated DTMF tones in order to ring a telephone 50 interconnected with the answering machine 40.

When sequential incoming DTMF codes on the input jack 18 match the DTMF codes associated with the settings of the switches 12 of the ARCS 10, the telephone 50 interconnected with the answering machine 40 rings. A ring back tone is then sent back from the ARCS 10 to the calling party to indicate that the proper sequence of designated DTMF tones has been entered and the telephone ringer is active. The ARCS 10 then produces an audible ring through speaker 14, and a ring back tone is sent to the calling party to indicate that the proper sequence of DTMF tones has been recognized and processed. When sequential incoming DTMF tones on the input jack 18 do not match the DTMF tones associated with the settings of the switches 12, the ARCS 10 does not produce an audible ring through speaker 14, and no ring back tone is sent to the calling party. As described above for a telephone 50, a number of ARCS devices 10 may be interconnected between the telephone 50 and the answering machine 40 to enable a user to recognize who the calling party is prior to answering the telephone 50.

Emergency calls may be handled in a variety of ways when an ARCS 10 is in use. A voice emergency message from the caller may be passed through to the called party at the time of the call, and may be saved on the answering machine 40. The answering machine 40 may also specify an emergency code in the answering message, which may be implemented by an additional ARCS interconnected between the telephone line and the answering machine 40.

The ARCS 10 does not preempt, disable, and/or exclude any functions of an existing interconnected telephone configuration to which it is attached, thereby precluding inadvertent blocked calls, such as emergency calls, outside the control of the user.

One example of an ARCS configuration includes the use of two ARCS devices 10 to signal emergency and personal calls from callers who do not know the proper sequence of designated DTMF tones for a particular one of the ARCS devices 10. The switches 12 on this particular ARCS 10 may be configured for a particular sequence of designated DTMF tones that may be known to a few selected individuals (such as 123). The switches 12 on the second ARCS 10 may be configured for a sequence of DTMF tones associated with emergencies and/or other personal calls, as indicated in the greeting message (such as 222). Such a sequence of DTMF tones may be provided in the greeting message or may be publicly notified to the public.

Another example of an ARCS configuration may provide a greeting message from an interconnected answering machine on a first ring. The greeting message may be something along the lines of “Hello, after the beep please press star followed by the proper three digit security code in order to ring our phones. If you make a mistake you can re-enter the sequence again with the star key. You will hear a ring back tone when the proper sequence is recognized. If we do not answer or if this is an emergency, please leave a message after the beep. Thank you.”

Another example of an ARCS configuration may provide enabling emergency rings to occur. The greeting message may be something along the lines of “Hello, after the beep please press star followed by the proper three digit security code in order to ring our phones. If you make a mistake you can re-enter the sequence again with the star key. You will hear a ring back tone when the proper sequence is recognized. If we do not answer please leave a message after the beep. If this is an emergency, dial ‘*, 1, 1, 1.’ A ring back tone will confirm this code has been received. If we do not answer, please leave a message after the beep. Thank you.”

Another ARCS configuration may provide one ARCS 10 to discourage solicitor phone calls. The switches 12 on this particular ARCS 10 may be configured for a particular sequence of designated DTMF tones, such as 123. A greeting message from an answering machine interconnected with the ARCS on the first ring may be “Hello, please press ‘*, 1, 2, 3’ to ring our phone. A ring back tone indicates that the proper code and ring signal is activated. The code can be repeated if no ring back is heard. If there is no answer please leave a message at the tone. Please note we are not accepting solicitor phone calls. Please do not enter the ring code if this is the case. Thank you very much.”

Another ARCS configuration may provide two ARCS devices 10 to create a private business phone for incoming calls. One of the ARCS devices 10 may be set for general calls, such as 111. The other ARCS 10 may be set for calls to a business phone, such as 222. A greeting message from an answering machine interconnected with the ARCS 10 on the first ring may be “Hello business calls to XYZ consulting please press ‘*, 2, 2, 2’. A ring back tone indicates that the proper code has been entered. For all other calls please press ‘*, 1, 1, 1’. Code can be re-entered if no ring back is heard. If no answer occurs, please leave a message at the tone.

The ARCS 10 allows incoming phone calls on traditional telephone lines to be checked at the location of the incoming call and telephone 50. The checking process requires a caller to dial a designated number sequence that the ARCS 10 detects, and creates an audible ring tone for the called phone when the ARCS 10 detects an incoming number sequence that matches the designated number sequence. The switches 12 on the ARCS 10 may be easily adjusted to obtain any number sequence according to the desires of the user. Without knowledge of the number sequence for a particular ARCS 10, callers are unable to enter the designated number sequence, and the called party does not have to respond or be disturbed. If multiple phones exist on a single line each phone may be interconnected with an ARCS 10 with switches 12 set to a particular number sequence for the particular ARCS 10.

Multiple ARCS devices 10 may be interconnected with multiple telephones used by multiple users on a single telephone line, whereby the switches 12 on each individual ARCS 10 for a particular user could be set to a particular setting associated with the particular interconnected telephone 50. A greeting message from an answering machine interconnected with ARCS devices 10 interconnected with multiple telephones 50 may be “Hello, after the beep please press star followed by the proper three digit security code in order to ring our phones. If you make a mistake you can re-enter the sequence again with the star key. You will hear a ring back tone when the proper sequence is recognized. Apartment 1 (John Doe)=111; Apartment 2 (Bill Smith)=222; Apartment 3 (Party 3)=3, etc. If we do not answer or if this is an emergency, please leave a message after the beep. Thank you.”

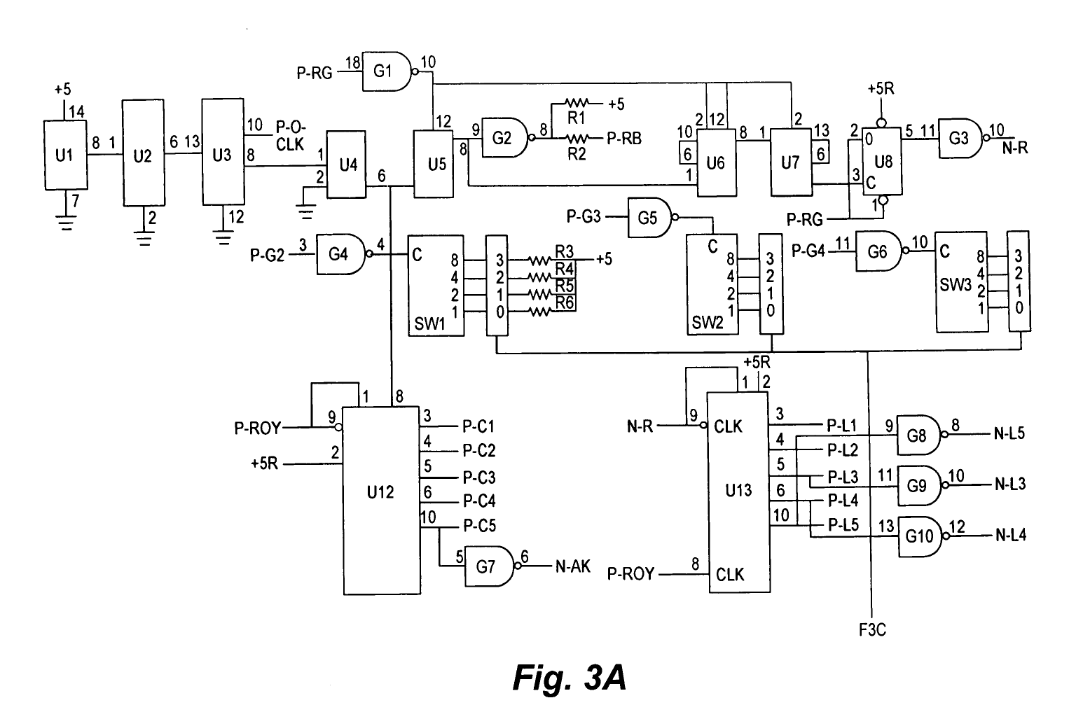

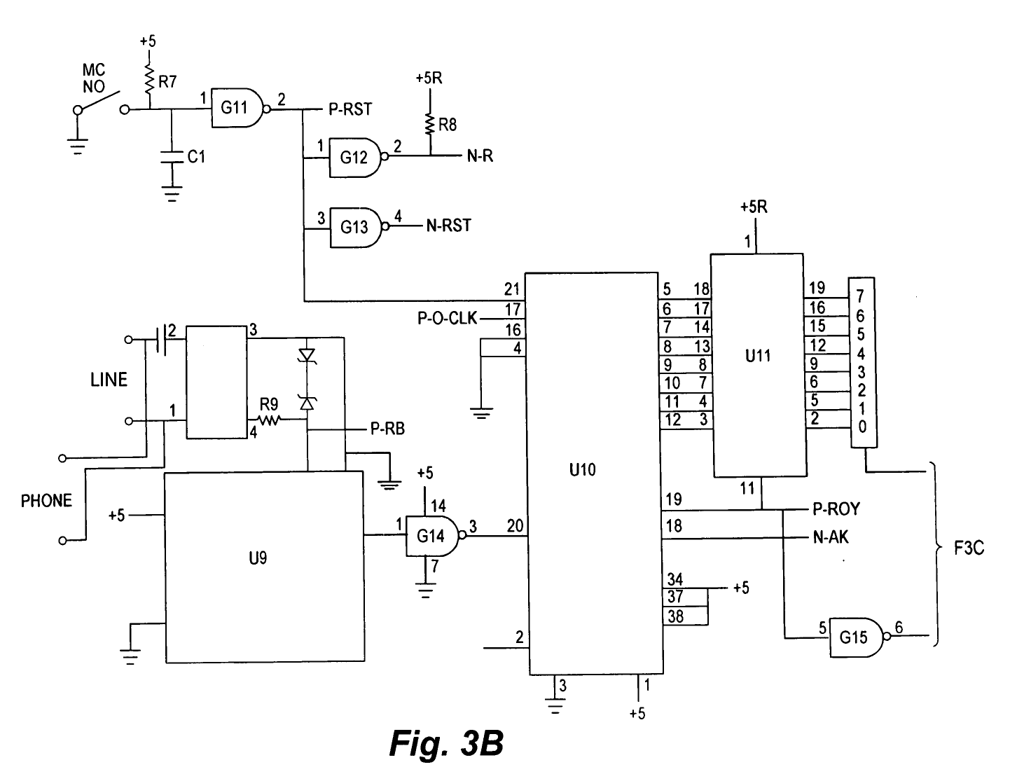

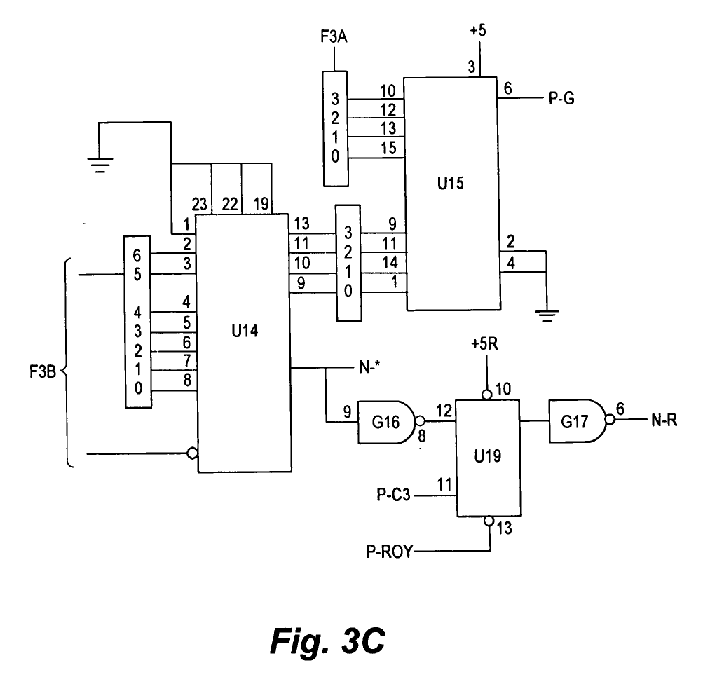

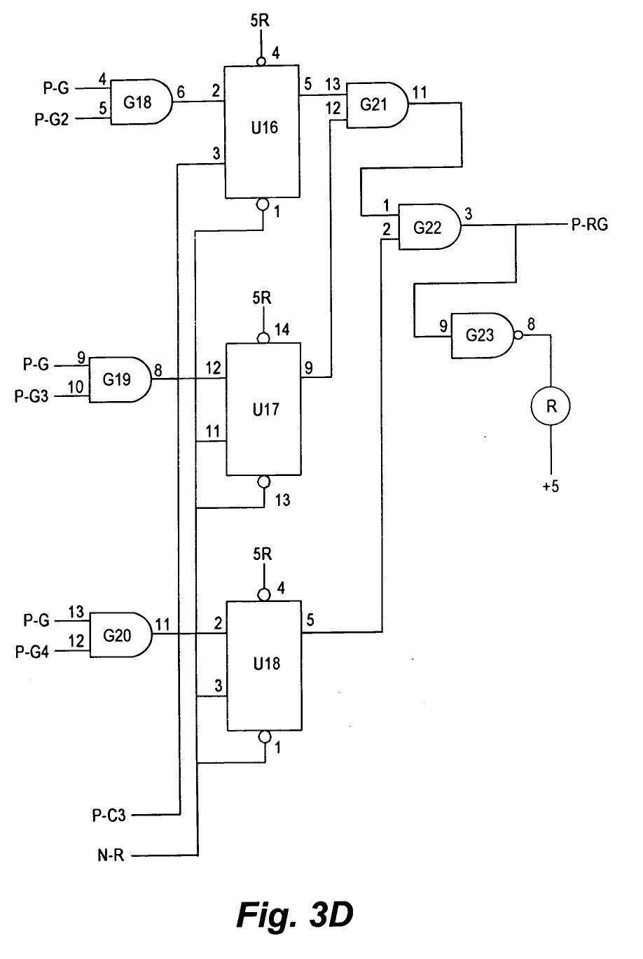

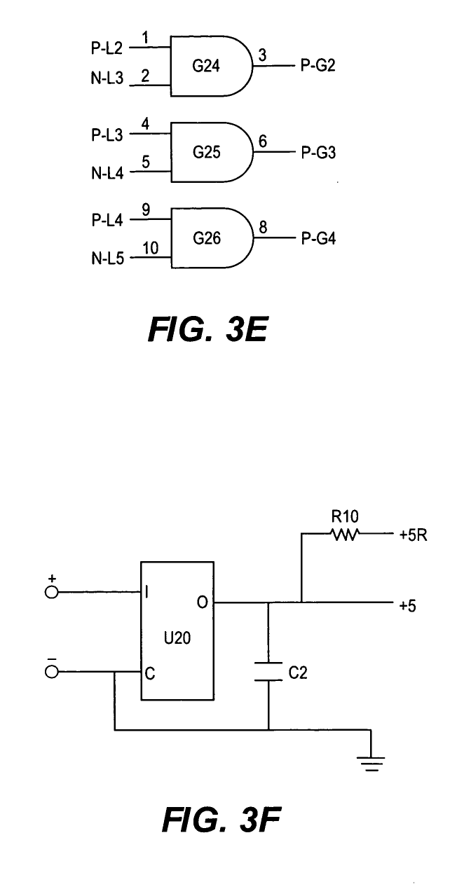

A circuit diagram of an example of ARCS circuitry is shown in FIGS. 3A-3F. The ARCS circuitry may be configured in various ways to perform substantially the same function in the substantially the same manner to achieve substantially the same results. For example, while the illustrated ARCS circuitry includes discrete components, economic circumstances may result in much or all of the ARCS circuitry being constructed as one or more integrated circuits. As illustrated, the ARCS circuit elements are preferably, but not limited to:

| Component | Part Number or rating |
|---|---|
| U1 | 10 MHz oscillator |
| U2 | 74LS393 4 bit binary counter |
| U3 | 74LS393 4 bit binary counter |
| U4 | 74LS393 4 bit binary counter |
| U5 | 74LS393 4 bit binary counter |
| U6 | 74LS393 4 bit binary counter |
| U7 | 74LS393 4 bit binary counter |
| U8 | 7805 3 pin +5 voltage regulator |
| U9 | DTMF decoder |
| U10 | TR1865 UART |
| U11 | 74LS273 8 bit latch |
| U12 | 74LS164 8 bit shift register |
| U13 | 74LS164 8 bit shift register |
| U14 | 2716 UV erasable PROM |
| U15 | LS85 4 bit comparator |
| U16 | 7805 3 pin +5 voltage regulator |
| U17 | 7805 3 pin +5 voltage regulator |
| U18 | 7805 3 pin +5 voltage regulator |
| U19 | 7805 3 pin +5 voltage regulator |
| U20 | 78L05 3 pin +5 volt regulator |
| G1 | 74LS04 Quad inverter |
| G2 | 74LS06 Quad inverter |
| G3 | 74LS06 Quad inverter |
| G4 | 74LS06 Quad inverter |
| G5 | 74LS06 Quad inverter |
| G6 | 74LS06 Quad inverter |
| G7 | 74LS04 Quad inverter |
| G8 | 74LS06 Quad inverter |
| G9 | 74LS04 Quad inverter |
| G10 | 74LS04 Quad inverter |
| G11 | 74LS04 Quad inverter |
| G12 | 74LS06 Quad inverter |
| G13 | 74LS14 Quad Schmidt trigger inverter |
| G14 | 75189 RS232 to TTL receiver |
| G15 | 74LS14 Quad Schmidt trigger inverter |
| G16 | 74LS04 Quad inverter |
| G17 | 74LS04 Quad inverter |
| G18 | 74LS08 Quad and gate |
| G19 | 74LS08 Quad and gate |
| G20 | 74LS08 Quad and gate |
| G21 | 74LS08 Quad and gate |
| G22 | 74LS08 Quad and gate |
| G23 | 74LS08 Quad and gate |
| G24 | 74LS08 Quad and gate |
| G25 | 74LS08 Quad and gate |
| G26 | 74LS08 Quad and gate |
| R1 | 5 Kohms |
| R2 | 27 Kohms |
| R3 | 1 Kohms |
| R4 | 1 Kohms |
| R5 | 1 Kohms |
| R6 | 1 Kohms |
| R7 | 1 Kohms |
| R8 | 1 Kohms |
| R9 | 1 Kohms |
| R10 | 1 Kohms |
| C1 | 68 uf |
| C2 | 68 uf |

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. An auxiliary ringer and call screener (ARCS) method comprising:
providing an ARCS with a housing, a plurality of switches interconnected with the housing, a speaker interconnected with the housing, a reset button interconnected with the housing, an input jack interconnected with the housing, an output jack interconnected with the housing, a power connecting jack interconnected with the housing, and ARCS circuitry mounted within the housing;
setting the plurality of switches with a corresponding number of DTMF tones;
decoding incoming DTMF tones from a calling party; and
producing an audible ring through the speaker of the ARCS and sending a ring back tone from the ARCS to a calling party to indicate that a proper sequence of DTMF codes has been recognized and processed, when sequential incoming DTMF codes from a call on the input jack match DTMF codes associated with the settings of the plurality of switches.

2. The ARCS method according to claim 1, further comprising:
providing the ARCS with a light emitting diode which illuminates when the ARCS produces an audible ring through the speaker.

3. The ARCS method according to claim 1, further comprising:
interconnecting the ARCS with utility power via the power connecting jack and a power cord; and
interconnecting the ARCS with a telephone line of a public telephone network via the input jack, a telephone cord, and an AC adapter.

4. The ARCS method according to claim 1, further comprising:
preventing an, audible ring from being emitted through the speaker of the ARCS, and sending no ring back tone to the calling party when sequential incoming DTMF codes from the call on the input jack do not match DTMF codes associated with settings of the plurality of switches.

5. The ARCS method according to claim 1, further comprising:
interconnecting the ARCS between an answering machine and a telephone line using telephone cords;
designating a sequence of DTMF tones on the ARCS with the plurality of switches;
detecting sequential incoming DTMF codes on the input jack of the ARCS;
evaluating the detected sequential incoming DTMF codes with the ARCS circuitry; and
determining whether the evaluated detected sequential incoming DTMF codes match the designated sequence of DTMF tones with the ARCS circuitry.

6. The ARCS method according to claim 5, further comprising:
answering an incoming call from a calling party on the answering machine on a predetermined ring; and
generating a prerecorded message in response to the answered incoming call informing the calling party that the calling party should enter a predetermined sequence of designated DTMF tones in order to ring a telephone interconnected with the answering machine.

7. The ARCS method according to claim 5, further comprising:
producing an audible ring through the speaker of the ARCS and sending a ring back tone from the ARCS to the calling party to indicate that a proper sequence of DTMF codes has been recognized and processed, when sequential incoming DTMF codes from the answered incoming call on the input jack match the predetermined sequence of DTMF codes associated with the settings of the plurality of switches.

8. The ARCS method according to claim 5, further comprising:
preventing an audible ring from being emitted through the speaker of the ARCS, and sending no ring back tone to the calling party when sequential incoming DTMF codes from the answered incoming call on the input jack do not match the predetermined sequence of DTMF codes associated with settings of the plurality of switches.

9. The ARCS method according to claim 5, further comprising:
passing through a voice emergency call to the called party at a time of a call; and
saving the voice emergency call on the answering machine.

10. The ARCS method according to claim 1, further comprising:
interconnecting more than one ARCS device between an answering machine and a telephone line using telephone cords;
designating a different sequence of DTMF tones for each ARCS with the associated plurality of switches;
detecting sequential incoming DTMF codes on the input jacks of the ARCS devices;
evaluating the detected sequential incoming DTMF codes with associated ARCS circuitry for each ARCS device; and
determining whether the evaluated detected sequential incoming DTMF codes match the designated sequence of DTMF tones associated with the ARCS circuitry of any associated ARCS device.

11. The ARCS method according to claim 10, further comprising:
producing a different audible ring through the speaker of each ARCS and sending a ring back tone from the associated ARCS to the calling party to indicate that a proper sequence of DTMF codes has been recognized and processed, when sequential incoming DTMF codes from the answered incoming call on the associated input jack match the predetermined sequence of DTMF codes associated with the settings of the plurality of switches for the associated ARCS.

12. An auxiliary ringer and call screener (ARCS)comprising:
a housing;
a plurality of switches interconnected with the housing;
a speaker interconnected with the housing;
a reset button interconnected with the housing;
an input jack interconnected with the housing;
an output jack interconnected with the housing;
a power connecting jack interconnected with the housing; and
ARCS circuitry interconnected with the housing;
wherein the ARCS is configured to produce an audible ring through the speaker of the ARCS and to send a ring back tone from the ARCS to a calling party to indicate that a proper sequence of DTMF codes has been recognized and processed, when sequential incoming DTMF codes from a call from the calling party on the input jack match DTMF codes associated with settings of the plurality of switches.

13. The ARCS according to claim 12, further comprising a light emitting diode which illuminates when the ARCS produces an audible ring through the speaker.

14. The ARCS according to claim 12, wherein the ARCS is interconnected with utility power via the power connecting jack and a power cord, and is interconnected with a telephone line of a public telephone network via the input jack, a telephone cord, and an AC adapter.

15. The ARCS according to claim 12, wherein an audible ring is prevented from being emitted through the speaker of the ARCS, and a ring back tone is not sent back to the calling party when sequential incoming DTMF codes from the call on the input jack do not match the DTMF codes associated with the settings of the plurality of switches.

16. The ARCS according to claim 12, wherein when the ARCS is interconnected between an answering machine and a telephone line using telephone cords, a sequence of DTMF tones is designated on the ARCS with the plurality of switches, the ARCS is configured for detecting sequential incoming DTMF codes on the input jack of the ARCS, evaluating the detected sequential incoming DTMF codes with the ARCS circuitry, and determining whether the evaluated detected sequential incoming DTMF codes match the designated sequence of DTMF tones with the ARCS circuitry.

17. The ARCS according to claim 16, wherein when the answering machine answers an incoming call from a calling party on the answering machine on a predetermined ring, a prerecorded message is generated in response to the answered incoming call informing the calling party that the calling party should enter the sequence of designated DTMF tones in order to ring a telephone interconnected with the answering machine.

18. The ARCS according to claim 16, wherein an audible ring is prevented from being emitted through the speaker of the ARCS, and a ring back tone is not sent to the calling party when sequential incoming DTMF codes from the answered incoming call on the input jack do not match DTMF codes associated with settings of the plurality of switches.

19. The ARCS according to claim 16, wherein a particular audible ring is produced through the speaker of the ARCS and a ring back tone is sent from the ARCS to the calling party to indicate that the proper sequence of DTMF codes has been recognized and processed, when sequential incoming DTMF codes from the answered incoming call on the associated input jack match the DTMF codes associated with the settings of the plurality of switches.

20. The ARCS method according to claim 16, wherein a voice emergency call is passed through to a called party at a time of a call, and the voice emergency call is saved on the answering machine.

21. The ARCS according to claim 12, wherein when more than one ARCS is interconnected between an answering machine and a telephone line using telephone cords, a different sequence of DTMF tones is designated on each ARCS with the associated plurality of switches, each ARCS is configured for detecting sequential incoming DTMF codes on the input jack of the ARCS, evaluating the detected sequential incoming DTMF codes with the associated ARCS circuitry, and determining whether the evaluated detected sequential incoming DTMF codes match the associated designated sequence of DTMF tones with the associated ARCS circuitry.

22. The ARCS according to claim 21, wherein each ARCS is configured to produce a different audible ring through the speaker of each ARCS and to send a ring back tone from the associated ARCS to the calling party to indicate that a proper sequence of DTMF codes has been recognized and processed, when sequential incoming DTMF codes from the answered incoming call on the associated input jack match the predetermined sequence of DTMF codes associated with the settings of the plurality of switches for the associated ARCS.
